(19) United States
(12) Patent Application Publication
(10) Pub. No.: US 2005/0075959 A1
(43) Pub. Date: Apr. 7, 2005

(54) Zero premium equity participating securities

(76) Inventors: Kevin G. Woodruff, New York, NY (US); Serkan Savasoglu, New York, NY (US); Nathan N. McMurtray, New York, NY (US)

Correspondence Address: MICHAEL D LAZZARA, ESQ;KIRKPATRICK & LOCKHART LLP, 535 SMITHFIELD STREET, HENRY W OLIVER BUILDING, PITTSBURGH, PA, 15222-2312, US

(21) Appl. No.: 10/679,071

(22) Filed: Oct. 3, 2003

(51) Int. Cl. G06F 17/60

(52) U.S. Cl. 705/35

(57) ABSTRACT

A unit, such as a unit structured mandatory convertible security, is disclosed. The unit may have a stated amount. According to one embodiment, the unit may include a fixed income security and a forward purchase contract, which are separable. The fixed income security may have a principal amount, a maturity date and an interest rate. The forward purchase contract may obligate a holder of the forward purchase contract to purchase a quantity of equity securities from an issuer of the unit at a settlement price no later than a settlement date specified in the forward purchase contract. The quantity of equity securities to be purchased by the holder may be determined by dividing the stated amount of the unit by the market price of the equity securities at the date the unit is issued.

### BACKGROUND OF THE INVENTION

The present invention relates generally to investment instruments and, more particularly, to systems and techniques for enhancing the economic benefits to the issuer of a specific type of investment security—unit structured mandatory convertible securities.

Firms have traditionally issued conventional securities such as straight debt and common stock in order to raise capital. In general, straight debt securities (e.g., bonds, notes, loans, mortgages) raise capital by borrowing and promising to repay a principal amount and interest on a specified future date(s). Common stock securities, on the other hand, raise capital by selling an equity interest in the firm.

In addition to conventional types of securities, firms also have a variety of more sophisticated hybrid investment instruments at their disposal. These hybrid securities often combine attributes of several different types of securities (e.g., debt components and equity components) and may change optionally or automatically at certain points in time or depending on market conditions. Convertible securities, such as convertible debt, for instance, provide the issuer and/or the holder with the option of exchanging the convertible securities for other securities, such as common stock. Convertible securities may be priced at a premium, yet may be attractive to investors due to the mix of features, for example, earning interest like bonds when the stock price is down or flat and increasing in value like common stock when the stock price rises.

Mandatory convertible securities are a type of hybrid that automatically converts from debt into common stock on a specified future date. Mandatory convertible securities typically pay interest like a debt security until conversion and have payoff functions that deliver a variable number of shares of common stock to the holder. Typically, the number of shares will depend on the market price of the stock over a measuring period shortly before the conversion date.

A relatively recent innovation has been to structure mandatory convertible securities as units, which include a fixed income security (such as a note) and a forward purchase contract. The fixed income security provides ongoing interest payments from the issuer to the holder until maturity and repayment of its principal amount when it matures. The forward purchase contract is an agreement requiring the holder to buy a quantity of common stock from an issuer for a given price on or before a certain settlement date. The number of shares to be purchased is determined by a payoff function that generally depends on the market price of the common stock over a measuring period shortly before the settlement date relative to specified threshold prices. Typically the issuer pays the holder specified contract adjustment payments during the life of the forward purchase contract to induce the holder to accept the payoff function.

The majority of unit structured mandatory convertible securities use a payoff function where two threshold prices (an upper threshold and a lower threshold) are selected such that after issuance the holder bears all risk of a decrease in the common stock price, does not benefit from any increase in the common stock price until an upper threshold is reached and thereafter shares a portion of the increase with the issuer.

FIG. 1 is a diagram of a typical payoff function for a conventional unit structured mandatory convertible security (e.g., a premium equity participating security (PEPS^{SM})). This type of payoff function is typically implemented by setting the lower threshold at the current price of the common stock ($30 in the example of FIG. 1) and setting the upper threshold at a specified premium to the current price of the common stock (e.g., a 20% premium over the current price, or $36 in the example of FIG. 1). The forward purchase contract then provides that on the settlement date a holder will receive a fixed maximum number of shares if the common stock price is at or below the lower threshold ($30 in FIG. 1) or a fixed minimum number of shares if the common stock price is at or above the upper threshold ($36 in FIG. 1). The fixed minimum and fixed maximum number of shares are determined by dividing the stated amount of the unit by the upper or lower thresholds, respectively. If the common stock price is between the threshold prices (i.e., between $30 and $36 in FIG. 1) then the holder receives a variable number of shares such that the value of the common stock received is equal to the stated amount of the unit.

The payoff function is a critical feature for unit structured mandatory convertible securities because a substantial portion of the economics for the issuer and the holder, including the value delivered in common stock and the value delivered in contract adjustment payments, is either determined or affected by it. Moreover, because unit structured mandatory convertible securities include a fixed income security, they can be designed to achieve tax deductions for the issuer on the interest payments made on the fixed income security. This is an important feature for many issuers since dividend payments on common stock and other equity securities are not tax deductible to the issuer.

In addition, because unit structured mandatory convertible securities ultimately convert into common equity, credit rating agencies typically treat these securities more like common stock than debt when determining the credit rating they assign to an issuer. The amount of outstanding common stock an issuer has relative to its amount of debt is generally an important factor in determining credit ratings. Increasing the common stock (or securities treated like common stock) outstanding usually improves the credit ratings assigned. In some cases, issuing common stock or unit structured mandatory convertible securities is essential for an issuer to avoid a credit rating downgrade. Since credit ratings often affect interest payments on existing debt, compliance with covenants in bank facilities and other agreements, and access to the capital markets, unit structured mandatory convertible securities provide important flexibility to issuers. Moreover, because of the tax deductions on the fixed income security, issuers that pay a common stock dividend may achieve better economics and similar credit rating agency treatment by issuing unit structured mandatory convertible securities rather than common stock.

Accordingly, developing unit structured mandatory convertible securities with economic characteristics and rating agency treatment similar to common stock but that retain the tax deductions of debt securities may have significant financial implications for issuers.

### SUMMARY OF THE INVENTION

In a one general respect, the present invention is directed to a financial unit. According to one embodiment, the unit includes two instruments: a fixed income security and a forward purchase contract, which are separable. The forward purchase contract may obligate the holder to purchase a quantity of equity securities (e.g., common stock) from an issuer of the unit (the equity securities may be issued by the issuer of the unit, or issued by another company and owned by the issuer of the unit) at a settlement price no later than a settlement date specified in the forward purchase contract. The quantity of equity securities to be purchased by the holder may be determined by dividing the stated amount of the unit by the market price of the equity securities on the date the unit is issued.

In addition, the forward purchase contract may further obligate the issuer of the unit to make one or more forward purchase contract adjustment payments to the holder of the forward purchase contract prior to the settlement date. The forward purchase contract may provide for payment(s) if, for example, at the time of issuance, the dividend rate on the equity securities exceeds the interest rate of the fixed income security. The amount of the forward purchase contract adjustment payment(s) may depend upon the difference between the dividend rate and the interest rate. According to other embodiments, the forward purchase contract may provide for payment(s) to induce investors to purchase the units. In that case, the amount of the payment(s) need not be dependent upon the difference between the dividend rate on the equity securities and the interest rate on the fixed income security.

Implementations of the unit may further include that the principal amount of the fixed income security may equal the stated amount of the unit. Further, the maturity date of the fixed income security may be at least two years after the specified settlement date of the forward purchase contract. Additionally, the fixed income security of the unit may be issued by the issuer of the unit, a subsidiary of the issuer of the unit, or a trust.

In another general respect, the present invention is directed to a method. According to various embodiments, the method includes issuing a unit, the unit including a fixed income security and a forward purchase contract, which are separable. In addition, the method includes purchasing, by a holder of the forward purchase contract, a quantity of equity securities from an issuer of the unit at a settlement price no later than a settlement date specified in the forward purchase contract. The quantity of equity securities purchased by the holder may be determined by dividing the stated amount of the unit by the market price of the equity securities at the date the unit is issued. Additionally, the method may further include the issuer of the unit paying to the holder of the forward purchase contract one or more forward purchase contract adjustment payments prior to the settlement date. The forward purchase contract may obligate the issuer to make the adjustment payments if, for example, at issuance, the dividend rate on the equity securities exceeds the interest rate of the fixed income security. According to other embodiments, the forward purchase contract may provide for one or more adjustment payments to induce investors to purchase the units. In that case, the amount of the payment(s) need not be dependent upon the difference between the dividend rate on the equity securities and the interest rate on the fixed income security.

Embodiments of the present invention provide a security that has the economic characteristics of common stock for the issuer and an investor. However, for the issuer the transaction structure provides tax deductions on the interest payments paid on the fixed income security, which are not available to the issuer when common stock is issued. In addition, for the investor, unlike typical unit structured mandatory convertible securities, the investor participates in any increase in the common stock price and does not share the benefit with the issuer. These and other benefits will be apparent from the description to follow.

### DESCRIPTION OF THE FIGURES

Embodiments of the present invention will be described by way of example in conjunction with the following figures, wherein:

FIG. 1 is a diagram of a payoff function for a conventional unit structured mandatory convertible security;

FIGS. 2-4 are diagrams illustrating a transaction structure according to various embodiments of the present invention;

FIG. 5 is a diagram of a payoff function according to various embodiments of the present invention;

FIGS. 6-9 are diagrams of various features of the transaction structure according to various embodiments of the present invention;

FIG. 10 is a diagram illustrating a method according to various embodiments of the present invention; and

FIG. 11 is a diagram illustrating a system according to various embodiments of the present invention.

### DETAILED DESCRIPTION OF THE INVENTION

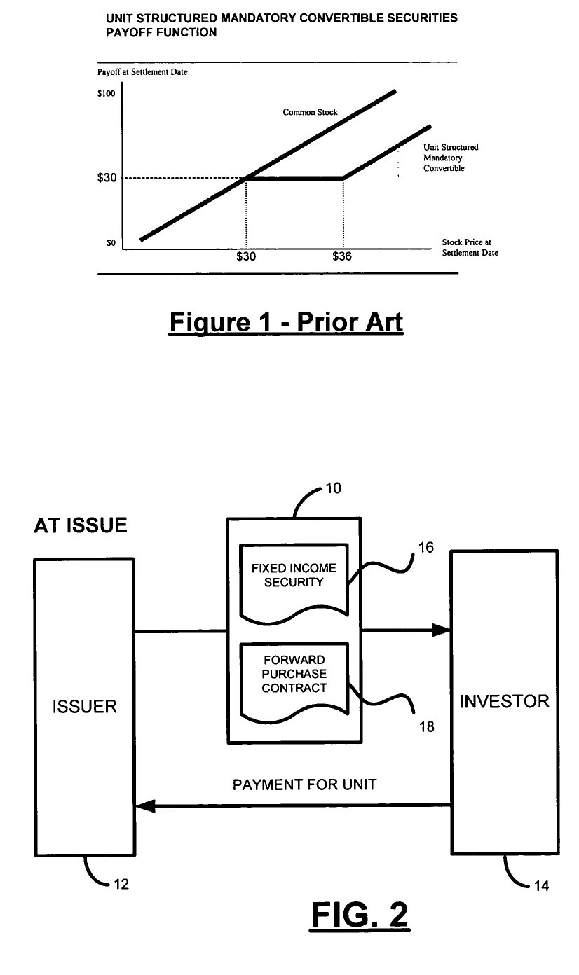

FIGS. 2-4 illustrate a transaction structure according to various embodiments of the present invention. Shown in FIG. 2 is a financial unit 10. The unit 10, as described in more detail below, may be a form of premium equity participating security. At the time of issue of the unit 10, an issuer 12 of the unit 10 issues the unit 10 to a buyer, e.g., an investor 14. The unit 10, as illustrated in FIG. 1, includes two instruments: a fixed income security 16 and a forward purchase contract 18. The two instruments may be separable. That is, a purchaser of the unit 10 may sell or otherwise transfer ownership of one or both of the instruments such that ownership of the instruments may be divided (i.e., separated). For convenience hereinafter, the investor 14 will be assumed to be the holder of the unit 10 in the description to follow unless a distinction is noted, with the recognition that the initial purchaser/investor need not be the continuing holder of the unit 10, and that new investors may subsequently come to hold one or both of the instruments 16, 18.

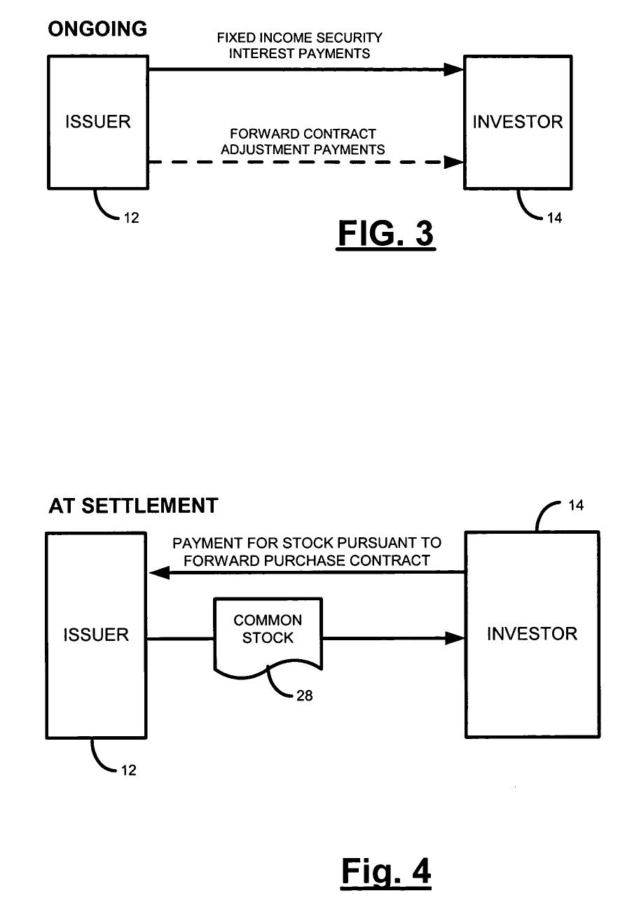

The fixed income security 16 may be, for example, a note, a bond or a trust-preferred security, and may provide for periodic interest payments from an issuer of the security 16 to the investor 14 until maturity, as shown in FIG. 3, and repayment of the principal amount of the fixed income security 16 at maturity. The principal amount of the fixed income security 16 may equal the stated amount of the unit 10. As described in more detail below, the issuer of the fixed income security 16 may be, for example, the issuer 12 of the unit 10, a subsidiary of the issuer 12 of the unit 10, or a trust.

The forward purchase contract 18 may include terms that require the investor 14 to purchase a quantity of equity securities (such as, e.g., common stock 28) from the issuer 12 at a settlement price on or before a settlement date specified in the forward purchase contract 18, as shown in FIG. 4. In addition, as described below, the forward purchase contract 18 may obligate the issuer 12 to make periodic payments to the investor 14 until the settlement date, as shown in FIG. 3. According to one embodiment, the forward purchase contract 18 may obligate the issuer 12 to make one or more forward purchase contract adjustment payments if, for example, at issuance, the dividend rate of the equity securities exceeds the interest rate of the fixed income security 16. According to other embodiments, the forward purchase contract may provide for payment(s) to induce investors to purchase the units. In that case, the amount of the payment(s) need not be dependent upon the difference between the dividend rate on the equity securities and the interest rate on the fixed income security. Additionally, the fixed income security 16 may be pledged by the investor 14 as security to cover the investor obligations under the forward purchase contract 18. Also, the term of the forward purchase contract 18 may be less than the maturity of the fixed income security 16 such as, for example, two or more years less than the maturity of the fixed income security 16.

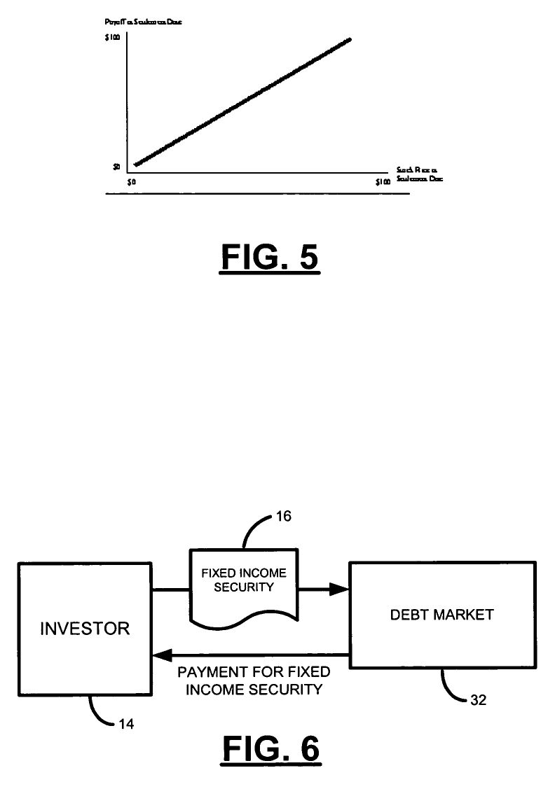

According to various embodiments, the payoff function of the forward purchase contract 18 may equate perfectly to an investment in the common stock 28. One mechanism to achieve this is to structure the payoff function to provide a fixed number of shares of the common stock in all instances, without regard to the price of the common stock at or near the settlement date, as shown in FIG. 5. Threshold prices are hence unnecessary in this structure, according to various embodiments. Rather, the number of shares of common stock delivered on the settlement date may be determined by dividing the stated amount of the unit 10 (which may equal the principal amount of the fixed income security 16) by the common stock price on the date the unit 10 is issued. The price paid by the investor 14 to settle the forward purchase contract 18 on the settlement date may be equal to the stated amount of the unit 10.

The issuer 12 of the unit 10 may be the issuer of the common stock purchased by the investor 14, although according to other embodiments the issuer of the common stock purchased by the investor 14 may be a different entity than the issuer 12 of the unit 10. This may be the case where, for example, the issuer 12 of the unit 10 owns stock of another (second) company and it is the stock of the second company that is purchased by the investor 14 at settlement.

Further, according to various embodiments, the forward purchase contract 18 may require the issuer 12 to make forward contract adjustment payments to the investor 14 under certain circumstances, as shown in FIG. 3. For example, forward contract adjustment payments might not be paid if the dividend rate on the issuer's common stock at the time the unit 10 is issued is less than or equal to the interest rate on the fixed income security 16 included in the unit 10 or if, for example, the investor 14 does not require such payments as inducement to purchase the unit 10. On the other hand, the forward purchase contract 18 may obligate the issuer 12 to make the one or more forward purchase contract payments where, for example, the dividend rate on the issuer's common stock at the time the unit 10 is issued exceeds the interest rate on the fixed income security 16 included in the unit 10, or where the forward purchase contract 18 requires such payments as an inducement to the investor 14 to purchase the unit 10. The amount of the forward purchase contract adjustment payments may be equal to, for example, the difference between the dividend rate on the issuer's common stock at the time the unit 10 was issued and the interest rate on the fixed income security 16 included in the unit 10 or some other amount (such as the amount required to induce the investor 14 to purchase the unit 10).

For the issuer 12, the effect of the foregoing transaction structure, according to various embodiments, is to create a security (i.e., the unit 10) that has the economic characteristics of common stock but provides tax deductions for the interest payments on the fixed income security 16. For an issuer that pays a common stock dividend, the tax savings compared to issuing common equity could be substantial. Moreover, because the payoff function may exactly replicate an investment in the common stock 28, as shown in FIG. 5, and because the unit 10 may automatically convert into common stock at the settlement date, credit rating agencies will generally treat the units 10 as very similar to common stock. Thus, the issuer 12 may achieve substantial economic benefits when issuing the units 10 compared to if it issued common stock.

For the investor 14, the foregoing transaction structure, according to various embodiments, preserves the primary economics of making an investment in the common stock 28. Unlike typical unit structured mandatory convertible securities, the investor 14 may participate in any increase in the common stock price immediately and does not share the benefit with the issuer 12. This is not the case for conventional unit structured mandatory convertible securities, as shown in FIG. 1. Rather, with the payoff function of FIG. 1, the investor 14 does not participate in any increase in the common stock price until the price reaches $36, and thereafter the investor 14 shares the benefit with the issuer 12.

In addition, according to various embodiments of the present invention, to the extent dividends are paid on the common stock prior to the settlement date, the investor 14 may be compensated by the interest paid on the fixed income security 16 and the forward contract adjustment payments on the forward purchase contract 18, if any. Further, from and after the settlement date, the investor 14 may actually hold the common stock 28 since the unit 10 has been converted (see FIG. 4). Thus, throughout the investor's investment period, the investor 14 may achieve economic treatment essentially equivalent to if the investor 14 had owned the issuer's common stock 28.

As mentioned previously, the fixed income security 16 and the forward purchase contract 18 of the unit 10 may be separable. That is, for example, the investor 14 may resell one or both the instruments after issuance. For example, as shown in FIG. 6, the investor 14 may resell the fixed income security 16 to a buyer in the debt market 32. The investor 14 may, for example, resell the fixed income security 16 before the settlement date of the forward purchase contract 18. This may be done in order that the investor 14 may raise the necessary proceeds to satisfy the investor's obligations to purchase common stock 28 from the issuer 12 under the forward purchase agreement 18. The issuer 12 may be obligated to pay a remarketing agent a fee to facilitate the resale, or such fee may be paid out of the excess, if any, of the proceeds of the resale over the stated amount of the unit 10, in either case pursuant to the transaction documents. The terms, including the interest rate, on the fixed income security 16 may be changed to facilitate the resale at the necessary price. Where the fixed income security 16 is pledged to cover the investor's obligations under the forward purchase contract 18, if the investor 14 resells the fixed income security 16 prior to settlement the investor 14 may secure its obligations by delivering other assets, such as, for example, U.S. Treasury notes, to the issuer 12. In some cases, for example, if the investor 14 fails to resell the fixed income security 16 to a new investor or if the investor 14 does not perform his obligations under the forward purchase contract 18, the issuer 12 may, for example, dispose of the fixed income security 16 by exercising its rights as a secured party to satisfy the forward purchase contract 18 or the investor may be permitted to put the fixed income security to the issuer 12 for the stated amount of the unit 10.

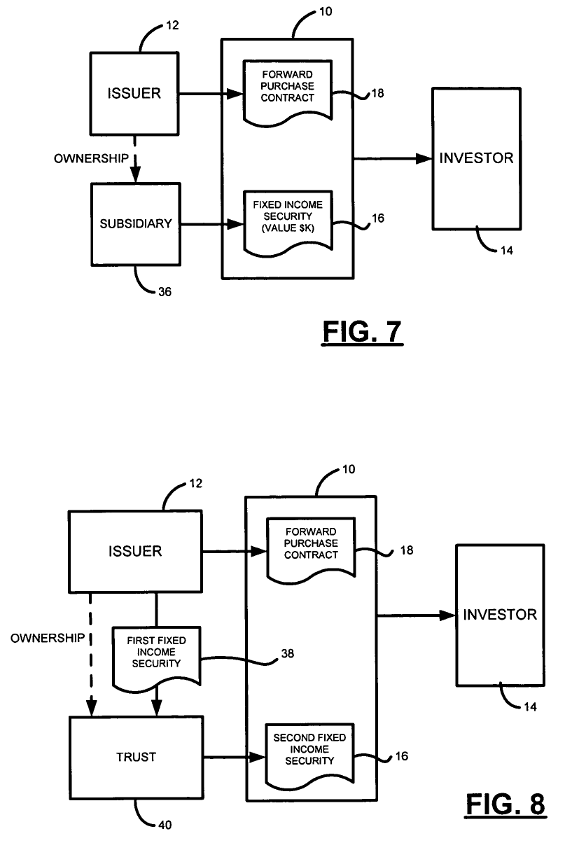

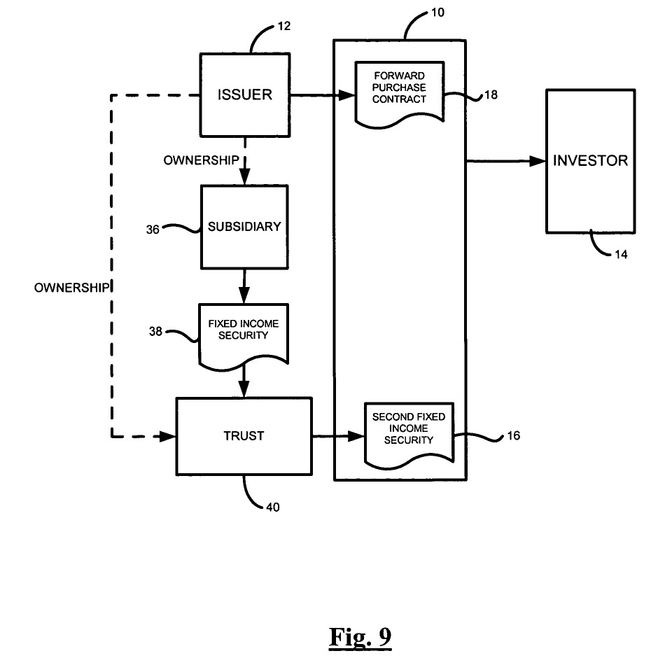

According to various embodiments, as described above, the fixed income security 16 may be issued by a subsidiary 36 of the issuer 12, as shown in FIG. 7. The economic and tax effects of the structure of FIG. 7 may be the same as described above for FIGS. 2-4 and the only structural difference may be the entity that issues the fixed income security 16, viz., the subsidiary 36 in FIG. 7 versus the issuer 12 in FIGS. 2-4. Implementations of the sort shown in FIG. 7 may also include a guaranty by the forward purchase contract issuer 12 of the obligations of its subsidiary 36 to pay the principal and interest on the fixed income security 16.

According to another embodiment, as illustrated in FIG. 8, the issuer 12 may issue a first fixed income security 38, such as for example, a note or a bond, to a trust 40. The issuer 12 may have an ownership interest in the trust 40. The trust 40 may then issue a fixed income security such as, for example, a trust-preferred security, that becomes the fixed income security 16 of the unit 10 purchased by the investor 14. A trust-preferred security is a security issued by a trust that may possess characteristics of both equity and debt issues. Again, like the structure of FIG. 7, the economic and tax effects of the structure of FIG. 8 may be the same as described above for FIGS. 2-4 and the only structural difference may be the entity that issues the fixed income security 16, viz., the trust 40 in FIG. 8 versus the issuer 12 in FIGS. 1-3. In addition, as before, the issuer 12 may guarantee the payment obligations of the trust 40 to pay the principal and interest on the fixed income security 16.

In addition, according to other embodiments, the structures of FIGS. 7 and 8 may be combined, as shown in FIG. 9. That is, for example, the subsidiary 36 of the issuer 12 may issue the first fixed income security 38 that is purchased by the trust 40. The trust 40 may then sell the second fixed income security 16 as part of the unit 10 to the investor 14. Again, the issuer 12 may guaranty the payment obligations of the subsidiary 36 and the trust 40 for the respective first and second fixed income securities 38, 16. Either the issuer 12 or the subsidiary 36 may have an ownership interest in the trust 40.

According to other various embodiments, the fixed income security 16 may be issued by a parent of the issuer 12 of the unit 10. That is, for example, the fixed income security 16 may be issued by an entity having an ownership interest in the issuer 12.

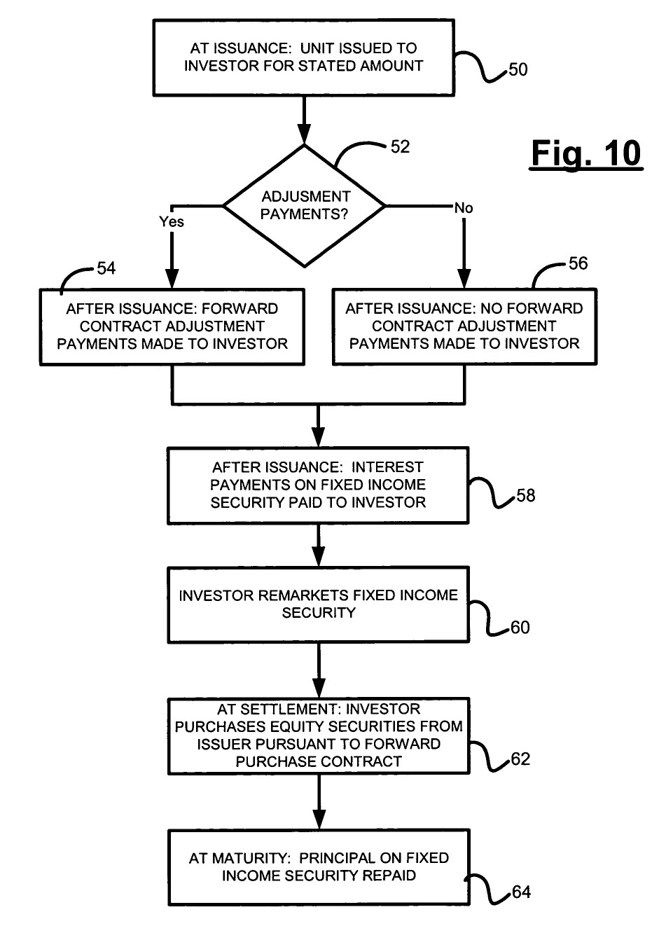

The present invention is also directed to a method, of which FIG. 10 is a flowchart according to various embodiments. The process may start at block 50, where, at issuance, the unit 10 is issued to the investor 14 in exchange for the stated amount of the unit 10 (which may equal the principal amount of the fixed income security 16). At block 52, at the time of issuance of the unit 10, it is determined whether additional forward purchase contract adjustment payments will be paid to the investor 14. Such payments may be provided for if, for example, as explained previously, the dividend rate on the equity securities at issuance exceeds the interest rate on the fixed income security 16 or if required to induce the investor 14 to purchase the unit 10. If the forward purchase contract 18 provides for such payments, the process advances to block 54, where, after issuance of the unit 10 and prior to settlement, the issuer 12 may make one or more forward contract adjustment payments to the investor 14 as holder of the forward purchase contract 18. The amount of the payment may be, for example, the difference between dividend paid on the issuer's common stock and the interest rate of the fixed income security 16 or some other amount. On the other hand, if at block 52 it is determined that the forward purchase contract 18 will not provide for such payments, the process advances to block 56, where, during the term of the forward purchase contract 18, no forward purchase contract adjustment payments are made to the investor 14.

Regardless of whether forward purchase contract adjustment payments are made to the investor 14, the investor 14, as holder of the fixed income security 16, may be paid interest payments on the fixed income security 16 by the issuer of the fixed income security 16, at block 58. As mentioned previously, the issuer of the fixed income security may be the issuer 12, the subsidiary 36 or the trust 40.

At block 60, the investor 14 may remarket the fixed income security 16. That is, as explained previously in connection with FIG. 6, the investor 14 may resell the fixed income security 16 to a new investor in the debt market 32. This step may be performed before the settlement date in order that the investor 14 may have sufficient proceeds to perform its obligations to purchase common stock from the issuer 12 under the forward purchase contract 18. At settlement, at block 62, pursuant to the forward purchase contract 18, the investor may purchase a quantity of equity securities (e.g., common stock) from the issuer 12. The payoff function to determine the quantity of shares may be as is shown in FIG. 5. That is, for example, the investor 14 may pay the price of the stated amount of the unit 10 in exchange for a quantity of shares determined by the ratio of the stated amount of the unit 10 to the price of the common stock on the date the unit 10 was issued.

At block 64, at the maturity date of the fixed income security 16, the issuer of the fixed income security 16 may repay the holder thereof (e.g., the new buyer in the debt market 32) the principal amount of the fixed income security 16. The issuer of the fixed income security 16 may be, for example, the issuer 12, the subsidiary 36 or the trust 40, as explained previously.

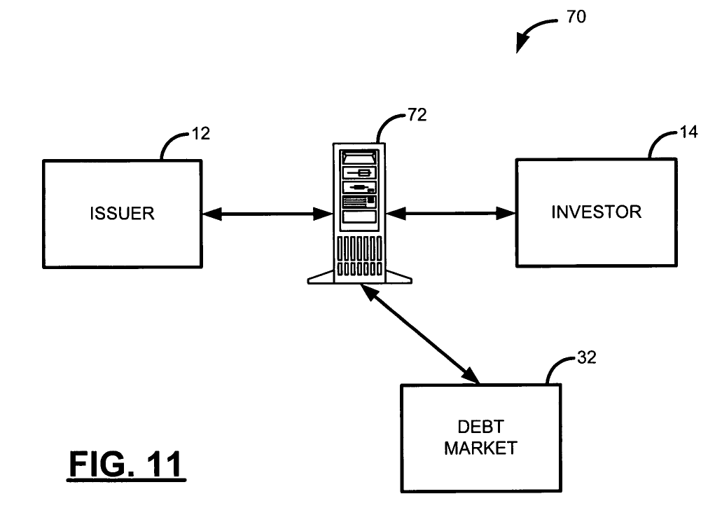

In addition, the step of remarketing the fixed income security 16 may be performed automatically, as shown in FIG. 11. FIG. 11 is a diagram of a system 70 for implementing features of the above-described methods according to various embodiments. The system 70 may include, as shown in FIG. 11, a computing device 72 in communication with accounts of the issuer 12 and the investor 14. The computing device 72 may also be in communication with buyers in the debt market 32.

According to one embodiment, at or near the settlement date, the computing device 72 may sell, on behalf of the investor 14, the fixed income security 16 to a new investor in the debt market 32. The computing device 72 may then, with the proceeds from the sale of the fixed income security 16, direct payment to the issuer 12 commensurate with the investor's payment obligations under the forward purchase contract 18 by electronically depositing the appropriate funds (e.g., the stated amount of the unit 10) into an account of the issuer 12. Any remaining proceeds from the sale of the fixed income security 16 to the debt market 32 may be electronically deposited in an account of the investor 14 or used to pay the fee of the remarketing agent (in which case the funds may be deposited in an account of the remarketing agent). In FIG. 11 the computing device 72 is shown as a single unit for purposes of convenience, but it should be recognized that the computing device 72 may comprise a number of distributed computing devices, inside and/or outside the same administrative domain.

In order to sell the fixed income security 16 in the debt market 32 and electronically deposit funds in accounts of the issuer 12 and/or investor 14, the computing device 72 may execute a series of instructions. The instructions may be software code to be executed by the computing device 72. The software code may be stored as a series of instructions or commands on a computer readable medium, such as a random access memory (RAM), a read only memory (ROM), a magnetic medium such as a hard-drive or a floppy disk, or an optical medium such as a CD-ROM, and may be written in any suitable computer language such as, for example, Java, C, or C++ using, for example, conventional or object-oriented techniques.

According to various embodiments, a separate entity such as, for example, an investment bank, may play a role in the transaction. For example, the investment bank may price the unit 10 for the offering. The investment bank may price the unit 10 using, for example, pricing models, data regarding recent similar deals, feedback from investors, etc. In addition, the investment bank may market the unit 10 to potential investors, underwrite the issuance of the unit 10, and arrange the transaction structure. Additionally, the investment bank may structure the unit 10, such as determining which entity issues the various instruments of the unit 10 and other features of the instruments.

While several embodiments of the present invention have been described herein, it should be apparent that various modifications, alterations and adaptations to those embodiments may occur to persons skilled in the art. For example, the steps illustrated in FIG. 8 may be performed in various orders. It is therefore intended to cover all such modifications, alterations and adaptations without departing from the scope and spirit of the present invention as defined by the appended claims.

1. A unit having a stated amount, comprising:
a fixed income security having a principal amount, a maturity date and an interest rate; and
a forward purchase contract, wherein the fixed income security and the forward purchase contract are separable, wherein the forward purchase contract obligates a holder of the forward purchase contract to purchase a quantity of equity securities from an issuer of the unit at a settlement price no later than a settlement date specified in the forward purchase contract, wherein the quantity of equity securities to be purchased by the holder is determined by dividing the stated amount of the unit by the market price of the equity securities at the date the unit is issued.

2. The unit of claim 1, wherein the principal amount of the fixed income security equals the stated amount of the unit.

3. The unit of claim 2, wherein the maturity date of the fixed income security is at least two years after the specified settlement date of the forward purchase contract.

4. The unit of claim 1, wherein the forward purchase contract further obligates the issuer of the unit to make at least one forward purchase contract adjustment payment to the holder of the forward purchase contract prior to the settlement date.

5. The unit of claim 4, wherein the amount of the at least one forward purchase contract adjustment payment is dependent upon the difference between the dividend rate on the equity securities and the interest rate.

6. The unit of claim 5, wherein the fixed income security is issued by the issuer of the unit.

7. The unit of claim 5, wherein the fixed income security is issued by a subsidiary of the issuer of the unit.

8. The unit of claim 5, wherein the fixed income security is issued by a trust, wherein at least one of the issuer and a subsidiary of the issuer has an ownership interest in the trust.

9. The unit of claim 8, wherein the fixed income security is a trust-preferred security.

10. The unit of claim 1, wherein the fixed income security is a bond.

11. The unit of claim 1, wherein the issuer of the unit is not the issuer of the equity securities.

12. The unit of claim 1, wherein the fixed income security is issued by a parent of the issuer of the unit.

13. A method, comprising:
issuing a unit, the unit including a fixed income security and a forward purchase contract, wherein the fixed income security and the forward purchase contract are separable; and
purchasing, by a holder of the forward purchase contract, a quantity of equity securities from an issuer of the unit at a settlement price no later than a settlement date specified in the forward purchase contract, wherein the quantity of equity securities purchased by the holder is determined by dividing the stated amount of the unit by the market price of the equity securities at the date the unit is issued.

14. The method of claim 13, wherein the equities securities include common stock.

15. The method of claim 13, wherein the fixed income security is a bond.

16. The method of claim 13, further comprising the issuer of the unit paying to the holder of the forward purchase contract at least one forward purchase contract adjustment payment prior to the settlement date.

17. The method of claim 16, wherein the amount of the at least one forward purchase contract adjustment payment is dependent upon the difference between the dividend rate and the interest rate.

18. The method of claim 17, further comprising paying at least one interest payment to a holder of the fixed income security after issuance of the unit.

19. The method of claim 18, wherein the maturity date of the fixed income security of the unit is at least two years after the specified settlement date of the forward purchase contract.

20. The method of claim 18, further comprising the purchaser of the unit reselling the fixed income security.

21. The method of claim 20, wherein reselling the fixed income security includes the purchaser reselling the fixed income security no later than the settlement date.

22. The method of claim 21, wherein the holder of the forward purchase contract purchasing the quantity of equity securities includes the purchaser of the unit purchasing the quantity of equity securities with proceeds from resale of the fixed income security.

23. The method of claim 17, further comprising a subsidiary of the issuer of the unit issuing the fixed income security.

24. The method of claim 23, further comprising the issuer of the unit guarantying payment obligations of the subsidiary.

25. The method of claim 17, further comprising a trust issuing the fixed income security, wherein at least one of the issuer of the unit and a subsidiary of the issuer of the unit has an ownership interest in the trust.

26. The method of claim 25, further comprising the issuer of the unit guarantying payment obligations of the trust.

27. The method of claim 25, wherein the fixed income security includes a trust-preferred security.

28. The method of claim 25, further comprising the trust purchasing a second fixed income security.

29. The method of claim 25, further comprising the trust purchasing a second fixed income security issued by a subsidiary of the issuer of the unit.

30. The unit of method of claim 13, wherein the issuer of the unit is not the issuer of the equity securities.

31. A system, comprising a computing device for reselling a fixed income security on behalf of an investor, wherein the fixed income security was issued as part of a unit further including a forward purchase contract, wherein the fixed income security and the forward purchase contract are separable, wherein the forward purchase contract obligates a holder of the forward purchase contract to purchase a quantity of equity securities from an issuer of the unit at a settlement price no later than a settlement date specified in the forward purchase contract, and wherein the quantity of equity securities to be purchased by the holder is determined by dividing the stated amount of the unit by the market price of the equity securities at the date the unit is issued.

32. The system of claim 31, wherein the forward purchase contract further obligates the issuer of the unit to make at least one forward purchase contract adjustment payment to the holder of the forward purchase contract prior to the settlement date.

33. The system of claim 32, wherein the amount of the at least one forward purchase contract adjustment payment is dependent upon the difference between the dividend rate and the interest rate.

34. The system of claim 33, wherein the computing device is further for electronically depositing at least a portion of the proceeds from the resale of the fixed income security in an account of the issuer of the unit.

35. The system of claim 34, wherein the computing device is further for electronically depositing a remaining portion of the proceeds from the resale of the fixed income security in an account of at least one of the holder and a remarketing agent.

36. A computer readable medium, having stored thereon instructions which, when executed by a computing device, cause the computing device to resell a fixed income security on behalf of an investor, wherein the fixed income security was issued as part of a unit further including a forward purchase contract, wherein the fixed income security and the forward purchase contract are separable, wherein the forward purchase contract obligates a holder of the forward purchase contract to purchase a quantity of equity securities from an issuer of the unit at a settlement price no later than a settlement date specified in the forward purchase contract, and wherein the quantity of equity securities to be purchased by the holder is determined by dividing the stated amount of the unit by the market price of the equity securities at the date the unit is issued.

37. The computer readable medium of claim 36, wherein the forward purchase contract further obligates the issuer of the unit to make at least one forward purchase contract adjustment payment to the holder of the forward purchase contract prior to the settlement date.

38. The computer readable medium of claim 37, wherein the amount of the at least one forward purchase contract adjustment payment is dependent upon the difference between the dividend rate and the interest rate.

39. The computer readable medium of claim 38, having further stored thereon instructions which, when executed by the computing device, cause the computing device to electronically deposit at least a portion of the proceeds from the resale of the fixed income security in an account of the issuer of the unit.

40. The computer readable medium of claim 39, having further stored thereon instructions which, when executed by the computing device, cause the computing device to electronically deposit a remaining portion of the proceeds from the resale of the fixed income security in an account of at least one of the holder and a remarketing agent.

41. A method, comprising pricing a unit for sale to potential investors, the unit including:
a fixed income security having a principal amount, a maturity date and an interest rate; and
a forward purchase contract, wherein the fixed income security and the forward purchase contract are separable, wherein the forward purchase contract obligates a holder of the forward purchase contract to purchase a quantity of equity securities from an issuer of the unit at a settlement price no later than a settlement date specified in the forward purchase contract, wherein the quantity of equity securities to be purchased by the holder is determined by dividing a stated amount of the unit by the market price of the equity securities at the date the unit is issued.
